(19) United States
(12) Patent Application Publication
(10) Pub. No.: US 2012/0095733 A1
(43) Pub. Date: Apr. 19, 2012

(54) METHODS, SYSTEMS, APPARATUSES, AND COMPUTER-READABLE MEDIUMS FOR INTEGRATED PRODUCTION OPTIMIZATION

(75) Inventor: David ROSSI, Katy, TX (US)

(73) Assignee: SCHLUMBERGER TECHNOLOGY CORPORATION, Houston, TX (US)

(21) Appl. No.: 12/981,945

(22) Filed: Dec. 30, 2010

Related U.S. Application Data
(60) Provisional application No. 61/350,540, filed on Jun. 2, 2010.

(51) Int. Cl. G06F 17/10

(52) U.S. Cl. 703/2

(57) ABSTRACT

A method, system, and computer readable storage medium according to an exemplary embodiment of the present disclosure, may (a) provide a non-linear deterministic model representing the production system, the model including one or more inputs and one or more outputs, and associating a PDF with one or more of a first input and a first output, wherein the first input and the first output are not measured and not deterministically known; (b) linearize the model, and obtain a measurement of one or more of a second input and/or a second output; (c) determine, using a joint mean and covariance, a joint uncertainty related to one or more of the inputs and outputs; and (d) determine, using the joint mean and covariance and the measurement, a conditional mean and covariance for the one or more of the first input and first output.

### CROSS-REFERENCE TO RELATED APPLICATION

This application claims priority, pursuant to 35 U.S.C. §119(e), to the filing date of U.S. Patent Application Ser. No. 61/350,540, entitled “Integrated Production Optimization,” filed on Jun. 2, 2010, with Attorney Docket No. 94.0271, which is hereby incorporated by reference in its entirety.

### BACKGROUND

Oil and gas field operators may strive to maximize hydrocarbon production rates and ultimate field recovery in the face of unknowns and associated business and technical risks. This challenge may be compounded by a number of factors, which may include one or more of the following:

1. Complex, integrated system: Oil and gas fields may be large-scale systems that include one or more interconnected elements (e.g., reservoir, wells, network, facilities), the management of which may span a number of disciplines and time-scales (for example, fast equipment operations, longer time scale production and reservoir management);

2. Time-varying: Assets may be characterized by pressures, temperatures and flow rates that may vary with time; these variations can be expressed mathematically in terms of relationships such as partial differential equations (PDEs); furthermore, variations may also be introduced by human manipulation, such as changing valve and equipment settings, as well as drilling of new wells;

3. Real-time measurements: in modern fields a large number of different types of real-time measurements may be acquired, such as pressure and temperature, flow rate, pump mechanical and electrical attributes, tank levels, etc.;

4. Software systems: various software systems may bring measurements together with mathematical models that represent the various subsystems; these software systems may extend across a range of spatio-temporal scales and measurement types, for example, to model pressure transients, flow through pipelines and equipment (e.g., SCHLUMBERGER's PIPESIM software), pumps and other fluid lifting systems in wellbores, etc;

5. Predict and control: oil and gas operators may mathematically simulate and predict field subsystems to obtain short- and long-term forecasts, which may become the basis for making field management decisions.

The oil and gas industry uses methods for combining different types of measurements with mathematical models in order to manage oil and gas fields. One notable advance is so-called Integrated Reservoir Management or “seismic-to-simulation” workflows, which may start with processing full-coverage seismic data and well logs, and proceed to modeling a reservoir system subsurface, including representing uncertainties in the reservoir model (e.g., see El Ouair, Y., Lygren, M., Osdal, B., Husby, O. and Springer, M., “Integrated Reservoir Management Approach: From Time-Lapse Acquisition to Reservoir Model Update at the Nome Field”, paper IPTC 10894, 2005). Such workflows may enable prediction or forecasting of future behavior, and may thereby assist with oilfield reservoir decision-making, such as where and when to place new wells, and how to drain hydrocarbons from various layers. See for example, “Seismic-to-simulation” workflows, including geostatistical (stochastic) modeling methods to handle uncertainties (e.g., see Deutsch, C. V., 2002. Geostatistical Reservoir Modeling, Oxford Univ. Press, 384 pp.). Such workflows have evolved into methods that optimize oil and gas reservoirs referred to as Integrated Reservoir Optimization (IRO) (see for example, U.S. Pat. Nos. 7,739,089 to Gurpinar et. al; 7,478,024 to Gurpinar; and 6,980,940 to Gurpinar).

Integrated production optimization methods and systems aimed at merging models for wells and production networks with real-time production data (pressures, temperatures and flow rates), can be used to predict or forecast future behavior and decide the best steps for managing field production. For example, such methods and systems may be used to set well pump rates and alter flow rates through surface flow lines.

One notable advance in this domain is Integrated Asset Modeling (JAM) (e.g., as described in Moitra, S. K., Chand, S., Barua, S., Adenusi, D., Agrawal, V., A Field-Wide Integrated Production Model and Asset Management System for the Mumbai High Field. Paper OTC-18678-PP, 2007), which is an integrated software modeling method that combines the reservoir model with production system and facilities models in order to jointly manage the combined reservoir and production systems. However, even with IAM, the production domain has not developed methods to characterize levels of uncertainty in the main production variables such as pressure, flow rate and temperature, and to use these uncertainties to manage technical and business risk.

Generally, compared to seismic-to-simulation workflows, there is a lack of stochastic modeling, as well as methods to perform data reconciliation (i.e., taking into account the possible redundancy and different levels of uncertainty in the different measurements and models, in order to resolve or reconcile differences among production system sensor data and mathematical modeling results).

Conventional methods, systems, and apparatuses for modeling oil and gas reservoirs are not ideal in all respects. Thus, there is a need for a general framework for integrated production optimization of oil and gas fields, as described in the present disclosure.

### SUMMARY

According to an embodiment of the present disclosure, a method of modeling a production system may include providing a non-linear deterministic model representing the production system, the model including one or more inputs and one or more outputs. The method may further include associating a prior probability density function (PDF) with one or more of a first input of the one or more inputs and a first output of the one or more outputs, wherein the one or more of the first input and the first output are not measured and not deterministically known. Further, the method may include linearizing the non-linear deterministic model, and obtaining a measurement of one or more of a second input of the one or more inputs and/or a second output of the one or more outputs. In addition, the method may include determining, using a joint mean and covariance, a joint uncertainty related to one or more of the one or more inputs and one or more outputs; and determining, using the joint mean and covariance and the measurement, a conditional mean and covariance for the one or more of the first input and first output. Another embodiment of the present disclosure may include a system for modeling a production system, wherein the system may include a memory, and a processor operatively connected to the memory and having functionality to execute instructions for performing the foregoing method.

Yet another embodiment of the present disclosure may include a computer readable storage medium storing instructions for modeling a production system, wherein the instructions when executed may cause a processor to perform the foregoing method.

### BRIEF DESCRIPTION OF THE DRAWINGS

The detailed description is described with reference to the accompanying figures. The same numbers are used throughout the drawings to reference like features and components.

FIG. 1 is a schematic illustration of an Integrated Production Optimization (IPRO) system according to an embodiment of the present disclosure.

FIG. 2a is a schematic illustration of a single branch network according to an embodiment of the present disclosure.

FIG. 2b is a schematic illustration of a software model for a subsea network according to an embodiment of the present disclosure.

FIG. 3a is a chart 300 that shows exemplary pressure and temperature solutions computed using software according to an embodiment of the present disclosure.

FIG. 3b is a table 301 showing the values for exemplary input parameters according to an embodiment of the present disclosure.

FIG. 3c is a table 302 showing software-computed pressure and temperature values at three specific points along a flow path, along with a liquid flow rate at standard conditions according to an embodiment of the present disclosure.

FIG. 3d is a table 303 showing the input parameters from the table 301 shown in FIG. 3b, expressed with a representative level of parameter uncertainty according to an embodiment of the present disclosure.

FIG. 3e is a table 304 showing the estimated pressure and temperature valves and liquid flow rate as described in FIG. 3c, along with levels of uncertainty.

FIG. 3f is a table showing a priori (before a rate measurement is incorporated) and a posteriori (after a rate measurement is incorporated) values and uncertainties for a plurality of parameters according to an embodiment of the present disclosure.

FIG. 3g is a table showing a posteriori estimates for mid-branch rate, pressure and temperature, given uncertain measurements of upstream and downstream pressures and temperatures according to an embodiment of the present disclosure.

FIG. 4 is a schematic illustration of a choke and flow line with three pressure and temperature measurements according to an embodiment of the present disclosure.

FIG. 5 is a chart that shows pressure differences used in data reconciliation that may also be used to identify drift in a sensor measurement according to an embodiment of the present disclosure.

FIG. 6 is a schematic illustration of a computational architecture to detect sensor drift according to an embodiment of the present disclosure.

FIG. 7 is a flowchart for modeling a production system according to an embodiment of the present disclosure

FIG. 8 is a schematic illustration of a computer system according to an embodiment of the present disclosure.

### DETAILED DESCRIPTION

An embodiment of the present disclosure includes methods, systems, apparatuses, and computer-readable mediums related to “Integrated Production Optimization” (IPRO), wherein the various modules may be inter-connected to provide high-level functionality required by oil and gas assets.

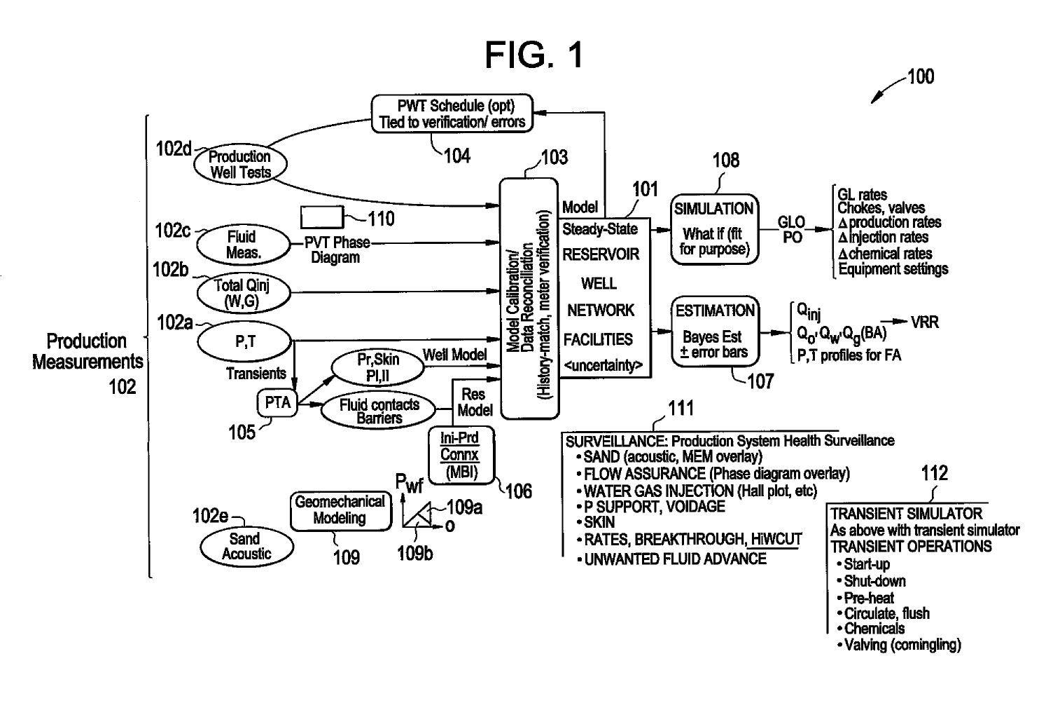

FIG. 1 shows an exemplary embodiment of an IPRO system 100. The IPRO system 100 includes a MODEL module 101 which may include one or more mathematical models to predict the response of the reservoir, wellbore, network and facilities. The MODEL module 101 may be a steady state model, as shown in FIG. 1, or alternatively may be a transient model, as known in the art. In an embodiment, the MODEL module 101 includes functions provided by SCHLUMBERGER's PIPESIM software (referred to herein as “PIPESIM software”). In various exemplary embodiments described herein, the PIPESIM software is used. However, it should be understood that in other embodiments according to the present disclosure, other modeling software may provide the data for MODEL module 101.

The models provided for use with MODEL module 101 may be combined and integrated using Integrated Asset Management (IAM) descriptions. In an embodiment, the IAM descriptions are provided by SCHLUMBERGER's AVOCET software product. However, other IAM software may also be used. The MODEL module 101 may enable a user to represent uncertainty related to key system variables such as pressure, temperature and flow rate.

PRODUCTION MEASUREMENTS module 102 may provide various types of real-time and occasional measurements. For example, PRODUCTION MEASUREMENTS module 102 may include one or more of the following measurements: (1) readings from pressure and temperature sensors permanently placed in the wells, trees, manifold, flow lines and facilities (as may be provided by P, T module 102a); (2) readings from injected fluid flow rate meters such as water and gas rate (as may be provided by Total Qinj module 102b); (3) measurements of fluid properties such as composition from fluid samples (as may be provided by Fluid Measurements module 102c); (4) production well tests providing water, oil and gas flow rates, for example, from scheduled separator well tests or multiphase flow meters (as may be provided by Production Well Tests module 102d); and (5) other measurements such as acoustic sand detectors using microphones clamped to production piping (as may be provided by Sand Acoustic module 102e). The foregoing measurements are merely exemplary, and in other embodiments, PRODUCTION MEASUREMENTS module 102 may include other measurements.

A CALIBRATION module 103 may history-match or otherwise validate the mathematical models of the MODEL module 101 using new measurement data in order to calibrate the mathematical models and to ensure that the data and models are self-consistent using various levels of measurement redundancy as known in the field of data reconciliation.

A PWT SCHEDULE module 104 may use knowledge of the level of flow rate uncertainty to optimize the scheduling of one or more production well tests (e.g., which well to test, how long to test) using oil/water/gas separation and metering equipment located in one or more surface facilities.

PTA module 105 may process data when a well experiences a sudden change in flow rate, for example, it may have been shut-in (i.e., flow rate stopped) for some reason. Data processing may include extracting the pressure measurements during the shut-in interval (e.g., transient data) for use in estimating the reservoir pressure (Pr) and wellbore skin, (i.e. information about producer well productivity index or injector well injectivity index). This data can be used to help refine well and/or reservoir models provided by MODEL module 101. This data may also be used to examine derivatives of late transient data on a log scale, and obtain information about spatial variations in fluid mobility at some distance from the wellbore associated with gas/oil/water fluid contacts and barriers or compartments.

An INJ-PRD CONNX module 106 may describe the degree of inter-connectedness between injection wells that inject fluids into a reservoir and producer wells that extract fluids from a reservoir. For example, the INJ-PRD CONNX module 106 may describe material balance with interference (MBI). This knowledge can be combined with other reservoir knowledge from PTA module 105 to refine a reservoir model provided in MODEL module 101. MBI functionality may be provided using software, such as SCHLUMBERGER's DECIDE! MBI software.

An ESTIMATION module 107 may extract calibrated models and uncertainty descriptions in the MODEL module 101, and use them together with recent measurement data to estimate system quantities with uncertainties. For example, if only combined rates are measured, such as total Qinj in the PRODUCTION MEASUREMENT module 102, the models provided by MODEL module 101 can be used to determine how much of the total is associated with each contributing well (i.e., the so called continuous injection allocation problem), along with uncertainty. Similarly, real-time data such as pressure and temperature can be combined with the models provided by MODEL module 101 to provide continuous estimates of oil, water and gas production flow rates (so called continuous production allocation), along with uncertainty. Knowledge of injection flow rates and production flow rates from wells can be used to compute voidage replacement ratios (VRR). Finally, the models provided by the MODEL module 101 can be used to estimate pressure and temperature profiles along the length of pipes, flow lines and risers with uncertainties, for later use in flow assurance.

A SIMULATION module 108 may extract calibrated models and uncertainty descriptions provided by MODEL module 101, and may use them to simulate or make short-term future predictions of system behavior, along with uncertainty. This allows so-called “what if” experiments to predict the response to various production decisions or actions and test for an optimal decision. This computation might use only the subset of the models provided by MODEL module 101 that are required to obtain a solution. For example, this SIMULATION module 108 may determine how to set valves in the network, and thus may require modeling only the network, not the reservoir, wells and facilities (so called “fit for purpose” modeling). This ability in module 108 allows methods that optimize the production system or gas lift system (PO and GLO respectively), resulting in the best settings for field controls, such as gas lift rates, chokes and valves, to vary production and injection flow rates, as well as chemical injection rates, and other general equipment settings.

A GEOMECHANICAL MODELING module 109 may provide geomechanical modeling of the earth formation around the wellbores. In an embodiment, the GEOMECHANCIAL MODELING module 109 may use knowledge of 3-dimensional oriented earth stress and the geometry of the wellbore in 3D to compute the rock strength and combinations of well flowing pressure (Pwf) and reservoir pressure (Pr) under which a well is safe to operate (planar area 109a) versus likely to fail and form high levels of sand inside the production wellbore (planar area 109b).

A PVT PHASE DIAGRAM module 110 may be used to compute the pressure-volume-temperature response for wellbore fluids (e.g., PVT Phase Diagram) using, for example, a “flash” computation.

Once the system 100 is implemented and data are input into the system 100 (e.g. via PRODUCTION MEASUREMENTS module 102) and processed, a SURVEILLANCE module 111 may be provided in order to provide a high-level view of the production system health surveillance by summarizing the health of a contributing module. SURVEILLANCE module 111 may include one or more of the exemplary modules described below.

In an exemplary embodiments of a SURVEILLANCE module 111, a SAND surveillance module may be provided to process continuous acoustic sand microphone data to alert when levels are high or increasing, and may overlay the current well flowing pressure Pwf (as may be provided by PRODUCTION MEASUREMENTS module 102) and reservoir pressure Pr (as may be provided by PTA module 105) and bottomhole flowing pressure Pwf in injector wells (as may be provided by PRODUCTION MEASUREMENTS module 102) from each well on top of the Geomechanical Modeling crossplot (as may be provided by module 109) to assure that the wellbore is not close to failing.

A FLOW ASSURANCE module may be provided in the exemplary surveillance module 111 to overlay the P, T profiles along the pipes, flow lines and risers (as may be provided by ESTIMATION module 107) on top of the PVT phase diagram (as may be provided by PVT PHASE DIAGRAM module 110) to assure that the system 100 is not close to forming unwanted solids.

Further, a WATER GAS INJECTION module may monitor water and gas injection rate estimates (as may be provided by ESTIMATION module 107) and pressure-temperatures (as may be provided by PRODUCTION MEASUREMENTS module 102) along with reservoir pressure Pr estimated in the injector wells (as may be provided by PTA module 105) using for example Hall plots or other injection key performance indicators to ensure that the injection process is behaving well.

An exemplary SURVEILLANCE module 111 may also include a P SUPPORT, VOIDAGE module that monitors reservoir pressure Pr (as may be provided by PTA module 105) and voidage replacement ratio VRR (as may be provided by ESTIMATION module 107) to assure that pressure is behaving as desired across a reservoir with respect to undesirable drop below bubblepoint pressure and possible formation subsidence.

SKIN surveillance module may be provided in an exemplary SURVEILLANCE module 111 to monitor estimates of wellbore skin factor (as may be provided by PTA module 105) to insure that it is not changing too fast or increasing above a certain threshold beyond which the well may need to be stimulated to restore production or injection levels.

A RATES, BREAKTHROUGH, HIWCUT module may monitor the estimated injection and production rates (as may be provided ESTIMATION module 107) as well as their time variations, derivatives and trends to spot anomalous conditions or limits of warning, such as, the arrival or breakthrough of water into an oil production well, or a high level of water cut on an oil production well that could trigger the start of artificial lift such as gas lifting.

Finally, an UNWANTED FLUID ADVANCE module may be provided as part of an exemplary SURVEILLANCE module 111 to monitor a location of estimated fluid contacts away from a well (module 105) or from the distribution of oil-water-gas saturations using simulator (module 108) to provide early warning if unwanted fluids, such as water or gas, are approaching an oil production well.

In an exemplary embodiment, the MODEL module 101 may include TRANSIENT SIMULATOR module 112, which may provide transient simulation capability. TRANSIENT SIMULATOR module 112 may provide support for transient operations such as one or more of the following: (a) starting up or shutting down a well, with associated issues of fluid cooling and formation in the pipes, flow lines and risers of unwanted solids such as wax, asphaltenes and hydrates; (b) pre-heating of shut-in lines in cold seawater environments to prevent problems when restoring oil production through the otherwise cool lines; (c) circulating and flushing of lines and injection of chemicals to inhibit formation of wax, asphaltenes and hydrates; and (d) changing well valving configurations to mix warmer oil with cooler oil to insure the mixture is hot enough to avoid solid formation. For example, transient simulator software, such as OLGA software distributed by SPT GROUP, or KONGSBERG's LEDAFLOW software may be used to implement some or all of the transient simulator module 112.

In summary, the system 100 shown in FIG. 1 may provide functionality sufficient to span a wide range of oil and gas production and reservoir engineering activities, including, for example, one or more of the following list of work activities that may be encountered: Model calibration and history matching; Data reconciliation; Meter verification; Production system health surveillance; Sanding surveillance; Flow assurance; Gas lift optimization; Production optimization; Pressure transient analysis; Estimation of water injection rates; Production well test management; Water and gas breakthrough surveillance; High WCUT surveillance (triggers gas lift); Well productivity/injectivity (skin damage); Water injection surveillance; Gas injection surveillance; Injector-producer connectivity; Pressure support surveillance; Continuous back-allocation; and Proactive surveillance of unwanted fluids.

As discussed in the following paragraphs with respect to various embodiments described herein, the system 100 may include software that performs methods for using uncertainty to history match and/or calibrate a production model. For example, an embodiment of the present disclosure may provide one or more of the following:

(1) explicitly track and account for uncertainties in model variables of importance;
(2) address data reconciliation in the context of variable uncertainty;
(3) reduce the level of human effort required to continuously calibrate production models;
(4) enable scheduling production well tests based on levels of production system uncertainty; and
(5) enable new learnings from pressure transient analysis (e.g. estimated reservoir pressure, wellbore skin, variations in mobility away from the wellbore) into the system models.

SINGLE BRANCH NETWORK MODEL. With continued reference to FIG. 1, MODEL module 101 may include a software system with one or more steady-state or transient mathematical models to predict the response of the reservoir, wells, network and facilities. Together with uncertainty modeling capability, this may provide a foundation for related activities, such as simulating model outputs with uncertainty (e.g., as may be provided by SIMULATION module 108), model calibration history-matching and data reconciliation (e.g., as may be provided by CALIBRATION module 103), estimation of key system variables including continuous back-allocation (e.g., as may be provided by ESTIMATION module 107), scheduling of production well tests (PWT Schedule module 104), meter verification (e.g., as may be provided by CALIBRATION module 103) and transient operations (e.g., as may be provided by TRANSIENT module 112).

In the present embodiment, details of the foregoing modules are further described and illustrated with representative calculations using examples that involve a single branch network having only a choke, flow line, and riser. With respect to more complex networks, the model shown in FIG. 1 may not fully illustrate the modules described above. As an example, continuous back-allocation, as may be provided by ESTIMATION module 107, may use wellbore inflow curves, and may require a coupled or combined well-network model. However, for purposes of simplicity and transparency of the example computations, the exemplary IPRO system 100 shown in FIG. 1 includes a simple single branch network model. These examples illustrate the computations and show how a representative deterministic commercial off-the-shelf software modeling system (such as PIPESIM software) may be adapted to perform uncertainty modeling and the associated tasks such as those described above with respect to the various modules included in the exemplary IPRO system 100. It should be understood that in practice, principles related to the exemplary embodiments described herein may also be used to model more complex scenarios, such as combined well-network systems with inflow curves.

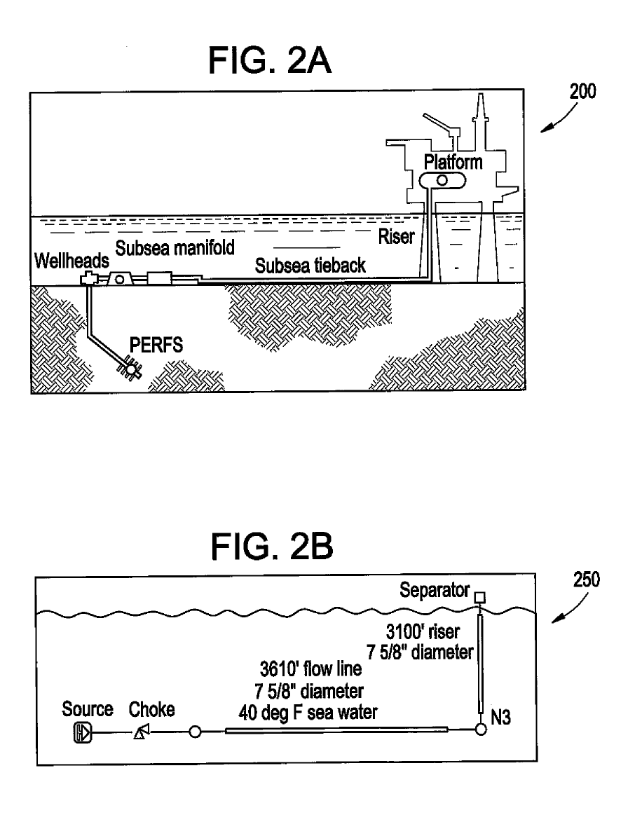

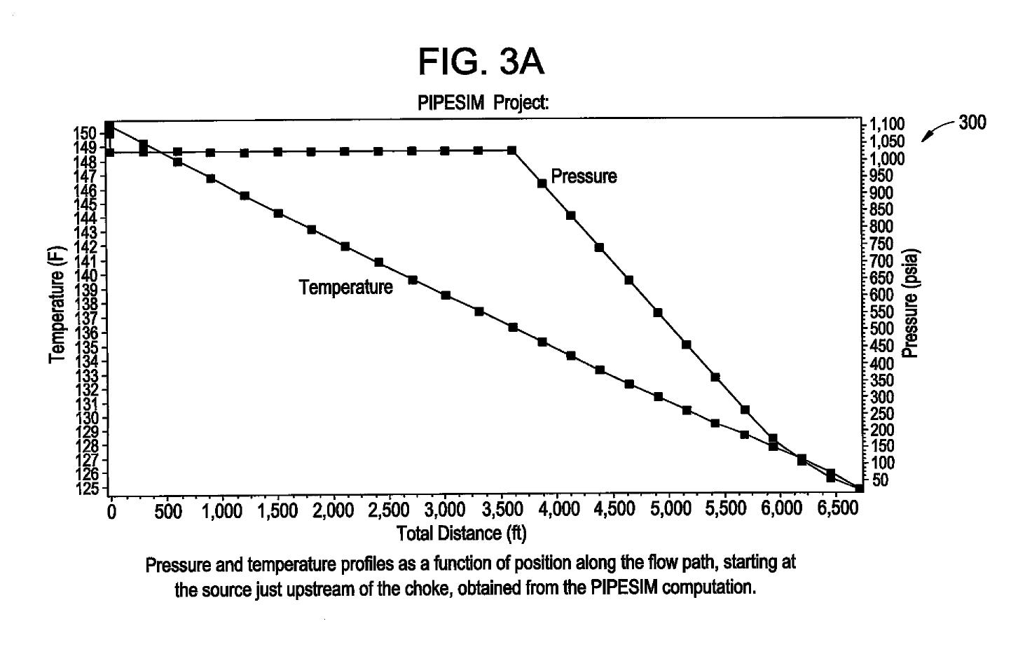

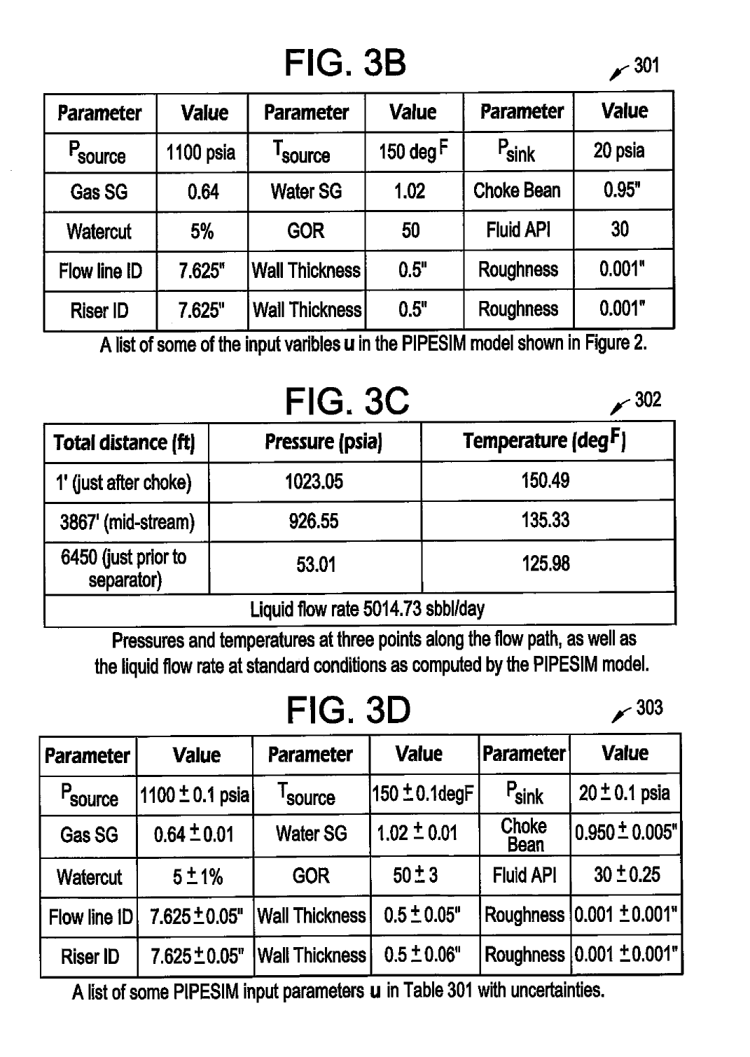

FIG. 2a shows exemplary single branch network 200. Specifically, single branch network 200 includes a subsea network extending from a well through a subsea flow line and a subsea riser up to the topsides equipment. A number of deterministic steady-state and transient modeling software systems may be used to model this network 200. For example, PIPESIM software, PETROLEUM EXPERT's PROSPER software (referred to herein as “PROSPER”), and SPT GROUP's OLGA software (referred to herein as “OLGA”), among other software known in the art, may be used to represent network 200. These modeling software systems may be described as “deterministic,” because for a given set of model input values the models compute a single set of output values. Inputs may include certain boundary conditions, such as downstream pressure and upstream pressure and temperature, as well as internal system parameters such as fluid properties (e.g., phase specific gravity, API, composition) and mechanical properties (e.g., pipe diameter, wall insulation and roughness). Outputs may include other boundary conditions, such as flow rate and downstream temperature. This may be contrasted with stochastic or probabilistic models, where inputs and/or outputs may be probabilistic, wherein, for example, each variable may be represented by a probability density function instead of a single number.

FIG. 2b shows a PIPESIM software model 250 for a portion of the example subsea network 200. Specifically, the PIPESIM software model 250 extends from a point just downstream of the wellhead and upstream of the subsea wellhead choke, through a subsea flow line and riser extending to the topsides. Some exemplary model details are indicated in FIG. 2.

PIPESIM software may provide a steady-state thermal-hydraulic simulator model that accepts certain inputs u and computes certain outputs v. The nonlinear simulator provided by PIPESIM software may be represented symbolically in this disclosure by the function F in Equation 1 below:

v=F(u) (Equation 1)

The input parameter set u of Equation 1 may include certain boundary conditions (e.g., downstream pressure, upstream pressure and temperature, as well as various fluid and piping properties).

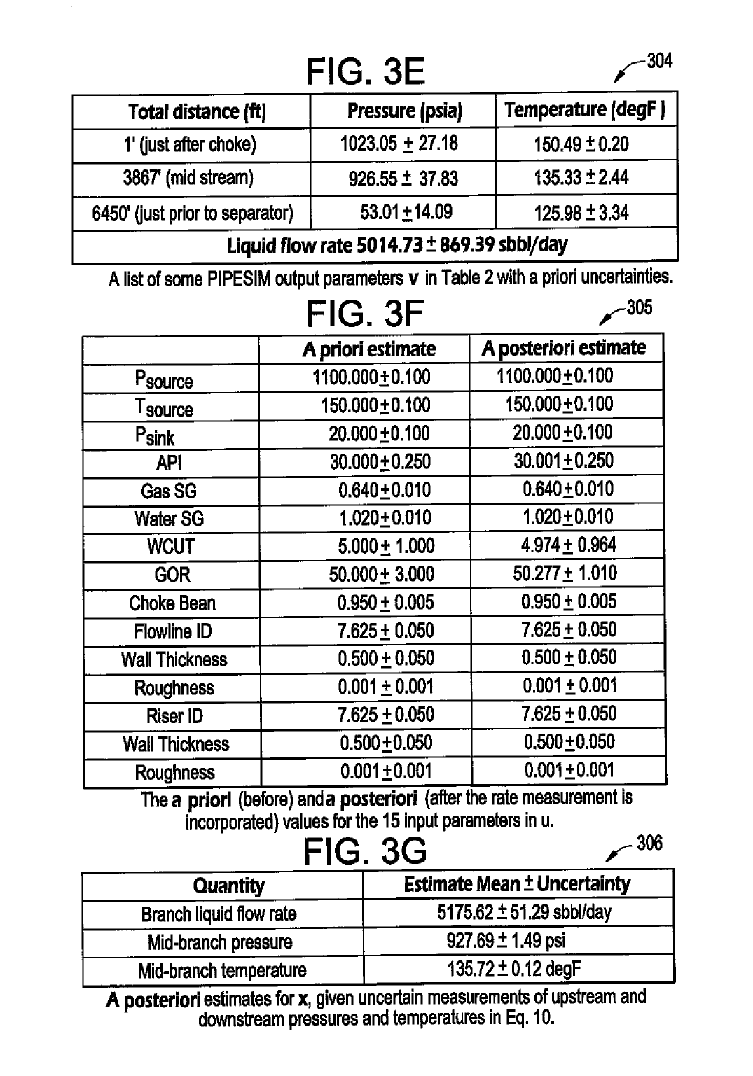

FIG. 3a is a chart 300 that shows an exemplary pressure and temperature solution computed using the PIPESIM software. FIG. 3b is a chart 301 that illustrates the values for some of the key PIPESIM software input parameters u for the current single branch example (P indicates pressure, T indicates temperature, SG indicates fluid specific gravity, GOR denotes gas-oil ratio, API denotes fluid API gravity and ID denotes pipe inside diameter; source denotes upstream and sink denotes downstream). FIG. 3c is a chart 302 that illustrates the PIPESIM software computed pressure and temperature values at three specific points along the flow path, along with the liquid flow rate at standard conditions.

Referring to FIG. 3a, the chart 300 shows pressure and temperature as a function of position along a flow path starting at the source just upstream of the choke. Most of the pressure decline may be hydrostatic pressure drop along the riser starting at the end of the 3610′ long flow line, whereas temperature decline due to thermal loss may occur steadily along the insulated flow line and riser.

The nonlinear function F in Equation 1 maps the multi-dimensional input vector u into the multi-dimensional output vector v. In the example provided in the remainder of the present disclosure, input vector u is represented by a 15-dimensional vector that includes the variables in chart 301, and the output vector v is represented by a 7-dimensional vector that includes the variables in chart 302.

MODEL module 101—Uncertainty Characterization. As described above, the steady-state thermo-hydraulic model F in Equation 1 may be a deterministic nonlinear simulator. Although F may be deterministic, the model inputs u might not be precisely known. For example, the model inputs u might not be precisely known because of one or more of the following:
the actual fluid in the production system may not be identical to the fluid sample(s) analyzed in the laboratory;
the detailed geometry and characteristics of the flow line and riser may not be completely known or have changed with time due to erosion, corrosion, build up of scale, wax, hydrates, or other solids, etc.;
the pressure and temperature boundary conditions may be measured using in-situ instruments that have small but non-negligible measurement errors.

FIG. 3d includes a chart 303 that shows the input parameters from chart 301, but now expressed with a representative level of parameter uncertainty. The actual values provided in this example are merely exemplary. In practice, other parameter uncertainty values may be chosen.

Prior Uncertainty. Chart 303 shows a level of uncertainty in some of the main PIPESIM software model input parameters a prior to taking any measurements of the system (so-called a priori level of uncertainty in the model inputs). Although the PIPESIM software model F is deterministic, the computed PIPESIM software outputs v=F(u) must now be considered as also being uncertain due to the uncertainty associated with the input parameters u. The a priori level of uncertainty in the PIPESIM software outputs v can be assessed in several ways. For example, Monte Carlo sampling may be used. One approximate technique is to linearize the PIPESIM software model F around the nominal parameter values u in chart 301 (these specific values of u may be represented as mᵤ in Equations 2a-2c below):

mᵥ=F(mᵤ) (Eq 2a)

mᵥ+δv=F(mᵤ+δu)=F(mᵤ)+∇_{F}δu+ . . . (Eq 2b)

δv≅∇^{F}δu (Eq 2c)

Equation 2b above expresses the nonlinear function F in a Taylor series expansion about the nominal input values mᵤ, where the series is truncated after two terms and ∇_{F} denotes the gradient of the function F. In this example, because F in Equation 1 maps 15-dimensional inputs u into 7-dimensional outputs v, the gradient ∇_{F} can be represented as a 7×15 matrix, where the (j, k) entry of the matrix is given by (∂F(u)ⱼ/∂uₖ). This matrix may be calculated in a straightforward way using perturbational PIPESIM software computations that does not require manual intervention and may be performed in an automated fashion using, for example, the OpenLink programmatic link to PIPESIM, or by analytically differentiating the internal PIPESIM software equations. Assuming that the locally linearized representation in Equation 2 is valid, variations in the input parameters ∂u can be related to variations in the PIPESIM software outputs ∂v. As an example, the input perturbations ∂u will be described as a random vector with a Gaussian probability distribution having mean mᵤ and covariance matrix Λᵤ. The linear relation in Equation 2c implies that the PIPESIM software output vector v is also Gaussian, with mean m_{y}=F(m₄) and corresponding covariance satisfying the following Equation 3 below (where ′ denotes matrix transpose):

Λᵥ=∇_{F}Λᵤ∇_{F}′ (Eq 3)

To illustrate with the current example, the 7×15 gradient matrix ∇_{F} was computed by perturbing PIPESIM software. The 15 diagonal elements of the covariance matrix Λᵤ were defined by squaring the fifteen standard deviations indicated in chart 303 shown in FIG. 3d. Computing the PIPESIM software output error covariance in Equation 3 provides the a priori estimate of the model output v along with levels of output uncertainty.

FIG. 3e is a chart 304 showing that prior to making measurements of the flow network, the prior estimates of pressures, temperatures and flow rates have considerable levels of uncertainty due to imprecise knowledge of the internal parameters, such as fluid properties and flow line attributes in the PIPESIM software model.

CALIBRATION module 103—Posterior Uncertainty—Updating the Model/Data Reconciliation. In an embodiment relating to “CALIBRATION module 103—Posterior Uncertainty—Updating the Model/Data Reconciliation,” suppose measurement sensors are installed along a flow network. For example, pressure and temperature gauges may take measurements at various points along a flow path. Multi-phase flow rate may be obtained by instruments in a flow line, or using separator well testing. When flow rate, pressure and temperature measurements are obtained, they may provide information that serves to reduce the uncertainty previously described. As illustrated in CALIBRATION module 103 shown in FIG. 1, new measurement data can be used to update or calibrate the mathematical models in CALIBRATION module 103. Further, different types of measurements such as pressure, temperature and flow rate may provide redundant information about a network. Because they measure different but related attributes, they may be cross-validated using a mathematical model such as a thermo-hydraulic fluid flow simulator such as that provided by PIPESIM software.

To illustrate, suppose that in the example presented earlier, a measurement of the liquid flow rate at standard conditions (with uncertainty) is made for the single branch network 200 shown in FIG. 2a. This would be the case, for example, if a well is put on production well test and the rate is determined from test separator accumulated volume or averaged instantaneous rates. Generally, the longer the stable test is carried out, the smaller the level of uncertainty on the flow rate measurement. The well test liquid rate measurement may be considered as new information about the network 200, and system identification methods may be used to refine the knowledge about the internal PIPESIM software system parameters u.

Consider a modified version of Equation 1 above, where now the PIPESIM software model is thought of as having the same 15 input parameters u and a single output q representing the branch liquid flow rate. This PIPESIM software model may be represented by the following Equation 4 below:

q=F_{q}(u) (Equation 4)

As earlier, with reference to parameters 303 in FIG. 3d, prior to the flow rate measurement, the input parameters u may be considered to satisfy a Gaussian probability density function with a priori mean mᵤ and covariance Λᵤ. As earlier, the nonlinear PIPESIM software model F_{q} may be expanded in a 2-term Taylor series approximation to arrive at Equations 5a-5c below:

m_{q}=F_{q}(mᵤ) (Eq 5a)

m_{q}+δq=F_{q}(mᵤ+δu)=F_{q}(mᵤ)+∇_{q}δu+ (Eq 5b)

δq≅∇_{q}δu (Eq 5c)

Suppose now that a liquid flow rate measurement is made of Q sbbl/day which is uncertain and has a standard deviation of σ_{q}. Because the model F_{q} in Equation 4 relates u and q, the flow rate q is statistically correlated to the PIPESIM software model inputs u. Because of this, we can use an uncertain measurement of q to learn something about (i.e., refine the estimates of) the inputs u. Note, however, that from the point of view of statistical degrees of freedom, such a computation uses a single uncertain flow rate measurement to learn something about 15 input parameters. A well-behaved algorithm should not radically alter the estimates for u, but instead is expected to gently “nudge” the parameter vector. We may see a change in the expected value or mean of u and a small reduction in the covariance for some of the elements in u, specifically those elements with higher sensitivity and good signal-to-noise ratio.

To illustrate an exemplary approach, we begin by creating a 16-dimensional vector [q; u]. Equation 5c can now be used to approximate the a priori joint probability distribution for this vector, which is Gaussian with 16×1 mean given by the Equations 6a-6b below:

$$[ \begin{matrix}{m}_{y} \\ {m}_{x}\end{matrix} ] \dot{=} [ \begin{matrix}{F}_{q} ( {m}_{u} ) \\ {m}_{u}\end{matrix} ] \qquad ( Eq 6 a )$$

and a 16×16 covariance matrix given by:

$$[ \begin{matrix}{Λ}_{y} & {Λ}_{yx} \\ {Λ}_{xy} & {Λ}_{x}\end{matrix} ] \dot{=} [ \begin{matrix}{∇}_{q} {Λ}_{u} {∇}_{q}^{′} + {σ}_{q}^{2} & {∇}_{q} {Λ}_{u} \\ {Λ}_{u}^{′} {∇}_{q}^{′} & {Λ}_{u}\end{matrix} ] \qquad ( Eq 6 b )$$

In the above Equations 6a-6b, we define new terminology on the left side, where the y subscript denotes the measured quantity (in this case q) and the x subscript denotes the estimated quantity (in this case u).

We may then make use of Bayes rule, as represented in Equation 7 below:

$$p ( x \vert y ) = \frac{p ( x , y )}{p ( y )} \qquad ( Eq 7 )$$

The conditional a posteriori mean and covariance for the 15-dimensional input parameters x=u after the measurement y=q=Q is taken into account are given by (e.g., as described in Mendel, J. M., Lessons in Digital Estimation Theory, Prentice-Hall, 1987, 306 pp.), as represented by Equations 8a-8b below:

E{x|y}=mₓ+Λ_{xy}Λ_{y}⁻¹(y−m_{y}) (Eq 8a)

Cov(x|y)=Λₓ−Λ_{xy}Λ_{y}⁻¹Λ_{yx} (Eq 8b)

Suppose, for purposes of illustration, that the actual flow rate measured value is 5100+−5 sbbl/day. Chart 305, which is shown in FIG. 3f, lists the a priori (before) and a posteriori (after the rate measurement is incorporated) values for the 15 input parameters in u, including updated uncertainty from Equation 8b above (values are shown to 3 decimal places to illustrate comparisons only). As expected, using a single uncertain measurement to refine 15 parameters results in a slight change to only two of the parameters, watercut (WCUT) and gas-oil ratio (GOR). In each case, the changes to the mean values were slight (0.05% and 0.5%) and the uncertainty levels decreased—slightly for watercut and more significantly for GOR. Because Bayesian updating is iterative, the a posteriori values in chart 305 may be used as the a priori values for the next iteration.

As a reminder, this exemplary embodiment may include updating the PIPESIM software model inputs u using a well test flow rate measurement. In other embodiments, well test allocation tied to a model (e.g., ESTIMATION module 107) may use wellbore inflow performance relations (IPR) curves, which would require a coupled or combined well-network model. In practice, the same methodology can be used to include well inflow performance curves for analyzing production well test results. Finally, it should be noted that in oil and gas fields one or more branches may be combined or commingled at a manifold and the combined fluid stream may be passed into the separator to measure combined oil, water and gas rates. By using the same methodology as above, but for multiple commingled branches, the total combined rate measurements can be used to refine the parameters in the contributing branches.

ESTIMATION module 107—Estimating Rates and Pressures with Uncertainties. During the course of production, real-time sensors may provide continuous streams of real-time pressure and temperature data at one or more locations along the fluid flow path between the toe of a well and one or more facilities. ESTIMATION module 107 shown in FIG. 1 may use such data in the context of an appropriate model in order to estimate dynamic network variables such as pressure and temperature at locations where sensors are not installed, or to use one type of measurement (e.g., pressure and temperature) to estimate another type of measurement (e.g., liquid flow rate).

To illustrate, suppose in the current example that two pressure-temperature gauges are placed in a single branch at the locations indicated in chart 302—one gauge located just downstream of (i.e., after) a choke, and another gauge located just upstream of (i.e., prior to) a separator. From the uncertain pressure-temperature measurements obtained at these two locations, a user may want to estimate (1) the pressure-temperature at a point mid-way between the sensors (e.g., at a location 3,867 feet along the flow stream near the sea bottom, as indicated (i.e., mid-stream) in chart 302), for example, for flow assurance reasons, as well as (2) the liquid flow rate in the branch.

Refer back to the PIPESIM software model 100 shown in Equation 1, where the inputs u are 15-dimensional (e.g., parameters in chart 305) and the outputs v are 7-dimensional (e.g., variables in chart 304). Note that some of the variables in v may be measured, while the unmeasured variables may be estimated. For this reason, the vector v may be partitioned into two parts, adopting the earlier notation where y denotes the measured quantity and x denotes the estimated quantity:

$$u = [ \frac{y}{x} ] \dot{=} [ \begin{matrix}{P}_{up} \\ {T}_{up} \\ {P}_{dn} \\ \frac{{T}_{dn}}{q} \\ {P}_{mid} \\ {T}_{mid}\end{matrix} ] \qquad ( Eq 9 )$$

Suppose, for sake of illustration, that the actual measurements y with uncertainty are represented by Equation 10 below:

$$\underline{Y} = [ \begin{matrix}{P}_{up} \\ {T}_{up} \\ {P}_{dn} \\ {T}_{dn}\end{matrix} ] = [ \begin{matrix}1021.0 \pm 0.1 \\ 149.0 \pm 0.1 \\ 54.6 \pm 0.1 \\ 127.0 \pm 0.1\end{matrix} ] \qquad ( Eq 10 )$$

Because the PIPESIM software model can relate y and x, the upstream and downstream pressures and temperatures y may be statistically correlated to the flow rate and mid-point pressure and temperature x. For this reason, we can make use of a measurement of y (with uncertainty) in Equation 10 to learn something about (i.e., refine the estimate of) the variables in x.

As described earlier, consider the vector v to be Gaussian with a priori mean given by the entries in chart 304. This may be represented by the following Equation 11a below:

$${m}_{u} = [ \frac{{m}_{y}}{{m}_{x}} ] = [ \begin{matrix}1023.05 \\ 150.49 \\ 53.01 \\ \frac{125.98}{5014.73} \\ 926.55 \\ 135.33\end{matrix} ] \qquad ( Eq 11 a )$$

From Equation 3 and the measurement uncertainties in Equation 10, the a priori covariance of v may be represented by Equation 11b below:

$${Λ}_{u} \dot{=} [ \begin{matrix}{Λ}_{y} & {Λ}_{yx} \\ {Λ}_{xy} & {Λ}_{x}\end{matrix} ] = {∇}_{F} {Λ}_{u} {∇}_{F}^{′} + [ \begin{matrix}{( 0.1 )}^{2} {I}_{4} & 0 \\ 0 & 0\end{matrix} ] \qquad ( Eq 11 b )$$

Here, I₄ denotes the 4×4 identity matrix, and the pressure and rate measurement noises are (without loss of generality; a more general scenario can be handled using non-zero off-diagonal terms in the matrix) assumed to be statistically independent and identically distributed (same size of statistical uncertainty; Equation 10). Proceeding in a similar manner as described with respect to Equation 7 and Equation 8 above, a posteriori estimates for a branch flow rate and mid-point pressure and temperature can be computed using Bayes Rule. Exemplary results are shown in chart 306, where the standard deviations are given by the square root of the diagonal entries of the a posteriori covariance matrix computed using Equation 8b above.

Note the significant reduction in uncertainties in the a posteriori values in the right column of chart 306 shown in FIG. 3g compared to the a priori values in chart 304 shown in FIG. 3e. For example, the uncertainty in liquid flow rate dropped from ±869 sbbl/day (prior in chart 304) to ±51 sbbl/day by incorporating the upstream and downstream pressure and temperature measurements. Similarly, uncertainty of the mid-branch pressure dropped from ±38 psi (prior in chart 304) to +1.5 psi, and mid-branch temperature uncertainty dropped from ±2.4 degF to +0.1 degF. Translating these uncertainties into practice, if the estimated mid-branch pressure and temperature are used for flow assurance, the (T, P) data can be plotted as an overlay on the P vs. T phase diagram for the flow line fluid (illustrated as module 110 in system 100 in FIG. 1, and obtained, for example, from a PVT flash computation). With uncertainties available, the overlay can be considered an elliptical area rather than a single point, with a one-standard deviation ellipse height in the P direction of ±1.49 psi and an ellipse width in the T direction of ±0.12 degF. The ellipse location on the cross-plot can be compared to the locations of phase transition curves to infer the possibility (and associated risk) of incipient formation of solids such as hydrates, wax or asphaltenes.

PWT SCHEDULE module 104—Production Well Test Scheduling. In an embodiment of the PWT SCHEDULE module 104, Production Well Tests may be scheduled. Specifically, the sequence of wells to be tested and the duration of each test may be defined. Recall that once a well test is performed, a new uncertain measurement of flow rate may be available for the selected branch, and the result may be used in CALIBRATION module 103 to update or calibrate the underlying well and network flow models. This may provide better understanding at the overall system level about how much of the total field production is coming from each well and branch (see the section above titled “CALIBRATION module 103—Posterior Uncertainty—Updating the Model/Data Reconciliation”).

New branch flow rate measurements are typically made using a multi-phase flow meter or a test separator, and the test may be carried out for a specified time interval. Generally, the longer the stable test time interval, the better the quality of the resulting flow rate measurement in terms of lower standard deviation. In some situations where the number of flow meters and test separators is smaller than the total number of wells/branches to be tested, a “Production Well Test Scheduling” activity is an optimization problem—i.e., how best to allocate limited flow rate measurement equipment resource to meet testing measurement objectives.

An approach to Well Test Scheduling may include performing off-line numerical “what if” evaluations using the current uncertain model for the production wells and network. By characterizing the well test error for each well or branch and knowledge of the way the error will decrease as the test duration increases (e.g. inverse of square root of time if measurement noise is statistically independent), then it is possible to evaluate ahead of time how each hypothetical allocation of limited well test measurement resource can reduce system uncertainty, and depending on the foregoing, select the well or branch for subsequent testing that maximally reduces the a posteriori model uncertainty.

CALIBRATION module 103—Meter Verification—Sensor Drift. As mentioned earlier, an embodiment of CALIBRATION module 103 may include the ability to carry out “meter verification” and “data reconciliation.” For example, this may include taking into account the possible redundancy and levels of uncertainty in the different measurements and models in order to resolve or reconcile differences among production system sensor data and mathematical modeling results. In an exemplary embodiment relating to meter verification and sensor drift, concepts of meter verification and data reconciliation may involve using available thermo-hydraulic mathematical system models found in MODEL module 101 to cross-validate different types of measurements, such as, e.g., pressure, temperature, and flow rate to assure that they are self-consistent. This might be done, for example, by considering two pressure measurements taken at successive points along a branch, and relating the pressure difference with the measured flow rate using a thermo-hydraulic model. The earlier embodiment related to “Updating the Model/Data Reconciliation” assumed that the measurement sensors are performing correctly and the uncertainty in each sensor measurement is due to zero-mean additive sensor noise. In some embodiments, a sensor may be experiencing drift, i.e., the sensor measurement might not be represented as the true variable value plus zero-mean additive sensor noise, but rather the sensor may be affected by a non-zero-mean additive bias or offset that may grow with time corresponding to sensor drift.

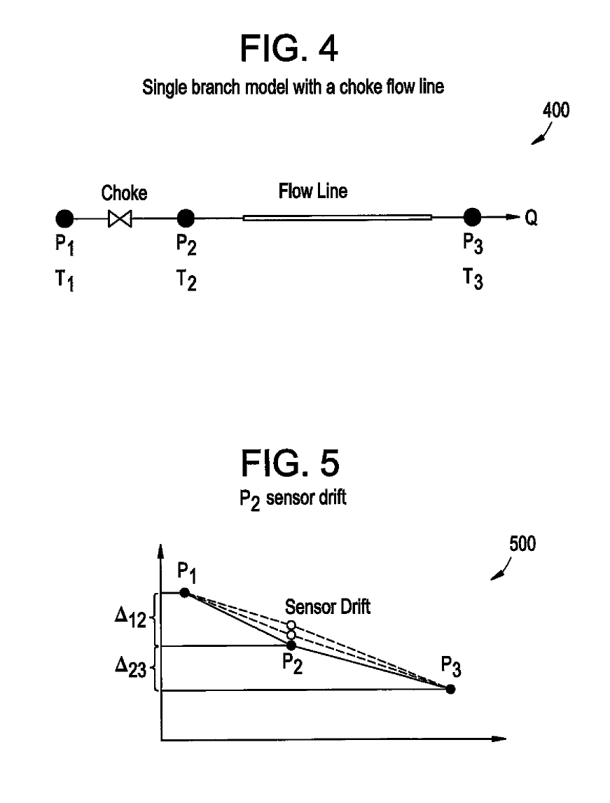

Consider a simple single branch, as illustrated in FIG. 4, which includes a choke and flow line with three pressure-temperature measurements. FIG. 5 illustrates exemplary pressure differences that may be used in data reconciliation.

Pressure difference Δ₁₂ represents the pressure difference or drop across the choke, and a simple thermo-hydraulic choke model may be used to reconcile or cross-check the branch flow rate Q with the pressure drop Δ₁₂. Pressure difference Δ₂₃ represents the pressure drop across the flow line, and a simple thermo-hydraulic flow line model may be used to cross-check the branch flow rate Q with the pressure drop Δ₂₃. In the earlier embodiment related to “Updating the Model/Data Reconciliation,” differences between the pressure drop and flow rate measurements were assumed to be entirely due to model calibration issues, and linearized Bayesian updating was described as a means to refine the model parameters to force a better fit between the measurements and the models. In an exemplary embodiment relating to meter verification and sensor drift, we allow that some of the difference may be due to meter drift and proceed accordingly.

Suppose, as illustrated in FIG. 5, that the pressure gauge providing measurement P₂ is drifting with time, thereby causing Δ₁₂ to be reported as smaller than its true value, and also causing Δ₂₃ to be reported as larger than its true value. If the earlier embodiment relating to “Updating the Model/Data Reconciliation” is used in this case, the model parameters for the choke and flow line will both change as time advances in order to force agreement between the choke and flow line models and the measured pressures and flow rate. In this case, the choke and flow line models may include the offsets due to gauge drift, which may not be desirable.

As an alternative, the exemplary methodology related to “Updating the Model/Data Reconciliation” can be modified to explicitly consider the possibility of sensor/meter drift and to statistically test for it. In an exemplary embodiment relating to relating to meter verification and sensor drift, this include evaluating time series residuals (y−m_{y}) (e.g., Equation 8a). With sensor drift, the residuals may be time-correlated (non-white), and in turn may be detected by testing the residuals for statistical whiteness. Specifically, if meter drift is detected, as described herein, it can be modeled separately from the choke and flow line and the estimated degree of drift can be introduced into short-term sensor corrections, and longer-term it can be used to flag the sensor for possible replacement during a future workover. Also, if dual pressure-temperature gauges are installed at the same location (not unusual with inaccessible subsea developments to offer additional robustness) meter drift detection can help to identify which sensor should be trusted more when two sensors at the same location are drifting apart.

Let P_{2, true}(t) denote the true time-varying pressure P₂ in FIG. 4. If the measurement of P₂ has unknown linear (i.e., other parametric drift rates can be assumed such as quadratic or exponential—in this embodiment, a linear model is chosen for sake of illustration without loss of generality) drift of rate a starting at time t₀, it can be represented as follows in Equation 12 below:

P₂(t)=P_{2,true}(t)+α(t−t₀) (Eq 12)

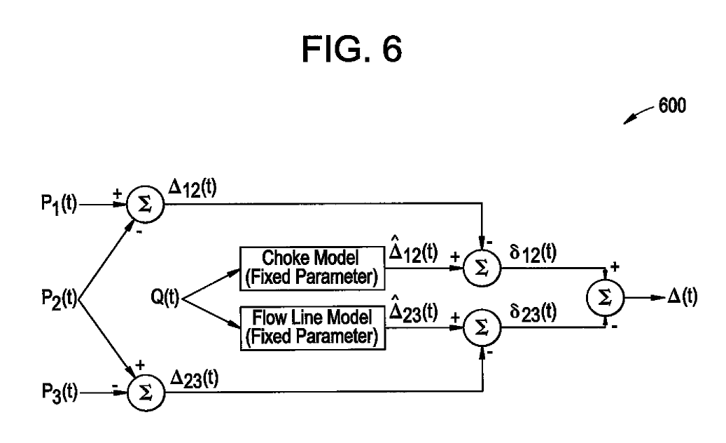

Consider the computational architecture shown in FIG. 6 which may be carried out over an extended interval of data over which the sensor may be experiencing drift. In this computation, the inputs consist of time series of the three pressures and one flow rate measured on the branch shown in FIG. 4. The pressure drops Δ₁₂ and Δ₂₃ may be computed as time series. Also, the flow rate measurement time series Q(t) may be used to calibrate a single (fixed parameter) choke model and flow line model, which may in turn be used to estimate (̂ notation) the pressure drops Δ₁₂ and Δ₂₃, which are subtracted from the measured drops to form drop differences δ₁₂(t) and δ₂₃(t). These may be subtracted to form the final time series Δ(t).

For the drift detection problem, consider the following two hypotheses:

(1) H₁(α): the hypothesis that the sensor P₂ is drifting with rate α

(2) H₀: the null hypothesis that the sensor P₂ is not drifting

Under the null hypothesis H₀ of no sensor drift, the fixed calibrated choke and flow line models should do a good job of representing the two pressure drop time series, in which case the drop differences δ₁₂(t) and δ₂₃(t) will be statistically characterized as zero-mean white (no time correlation) time series, as will the final output time series Δ(t).

Under hypothesis H₁(α) of a drifting sensor (i.e., Equation 12), the fixed calibrated choke and flow line models may be unable to represent the linearly increasing drift signals in the two pressure drop time series. In this case the pressure drop differences δ₁₂(t) and δ₂₃(t) may be statistically characterized as two linearly increasing signals (one of rate α and the other of rate −α) plus small levels of zero-mean white measurement noise. The final output time series Δ(t) may be computed as a difference of two opposing ramp signals, and may be statistically characterized as a linearly increasing signal (with rate 2α) plus small levels of zero-mean white measurement noise. Statistical methods such as Generalized Likelihood Ratio Testing (GLRT) may be used to (1) determine the maximum likelihood estimate α_{mL} for the rate α, and (2) use this estimate to test hypothesis H₁(α_{ML}) versus H₀.

TRANSIENT SIMULATOR module 112—Transient Operations. Earlier portions of the present disclosure have described the use of steady-state well and network models (e.g. as may be provided by PIPESIM software) to represent the wellbore and flow line pressure, temperature and flow rate behavior. These variables may be functions of position within the network and time. The steady-state models may identify solutions that are functions of position only (i.e. the pressure, temperature and flow rate solutions are time-invariant for the given fixed boundary conditions). These models may be adequate, for example, to detect network flow restrictions (bottlenecks), to evaluate well inflow and lift performance under steady conditions, etc.

However, oil and gas operators may require transient well and network modeling to handle situations where conditions are not time-invariant. This need may arise in particular with well and network fluids that are susceptible to forming solids under certain temperature and pressure conditions (e.g., wax, hydrates and asphaltenes; avoiding solid formation may be referred to as “flow assurance”). This can be a particular problem with sea-bottom flow lines sitting in cold sea water, which may be a few degrees above freezing. In this case, transient modeling capability may be needed, particularly during transient operations, such as one or more of the following:

(1) Start-up: During well start-up, hot reservoir fluid may flow up a producer well and into the cold subsea flow lines and riser. Rapid cooling of the reservoir fluids can result in significant formation of solids unless the subsea flow lines have been pre-heated prior to startup. For such situations, measurements and transient modeling may be needed to plan and assess start-up operations;

(2) Shut-in: If production is temporarily halted in a subsea environment, passage of hot reservoir fluids through the subsea flow lines and riser may cease and an entire system may begin to cool down. If proactive steps are not taken quickly (e.g. flushing the lines, circulating another fluid, or pre-injecting chemicals into the lines) fluids may cool to a critical point where solids may form. In this situation as well, measurements and transient modeling may be needed to plan and assess shut-in operations.

Software modeling codes exist to handle transient modeling, and these codes may reside in MODEL module 101 (alongside or replacing the steady-state modeling codes). The methodologies described earlier in the present disclosure may be applicable to transient modeling as well steady-state modeling, although the computational demands may grow with due to the time-dependent nature of the solution. In particular, Bayesian updating of model uncertainties that account for uncertainty in the measurements may still be applicable. However, other methods may need to be used to handle the Bayesian updating with a time-varying underlying system. These methods may include Kalman filtering and Extended (linearized) Kalman filtering, as described in Nævdal, G., Johnsen, L. M., Aanonsen, S. I., Vefring, E. H., Reservoir Monitoring and Continuous Model Updating Using Ensemble Kalman Filter, SPE Journal, Vol. 10, No. 1, 2005, and in the presence of strong nonlinearities, Ensemble Kalman filtering.

As described herein, embodiments of the present disclosure may include a framework for integrated production optimization of oil and gas fields. Specifically, exemplary embodiments may include a system architecture that brings together (1) modeling capability with (2) field sensor measurements, including measurement uncertainties. Furthermore, embodiments of the present disclosure may include using real-time sensor data together with uncertainty descriptions to update and calibrate models, estimate and predict key system variables, use measurement-model redundancies to cross-verify that different kinds of measurements are self-consistent, and determine if a sensor is drifting. As mentioned herein, these embodiments may be applicable to both steady-state and transient oil and gas systems and work processes.

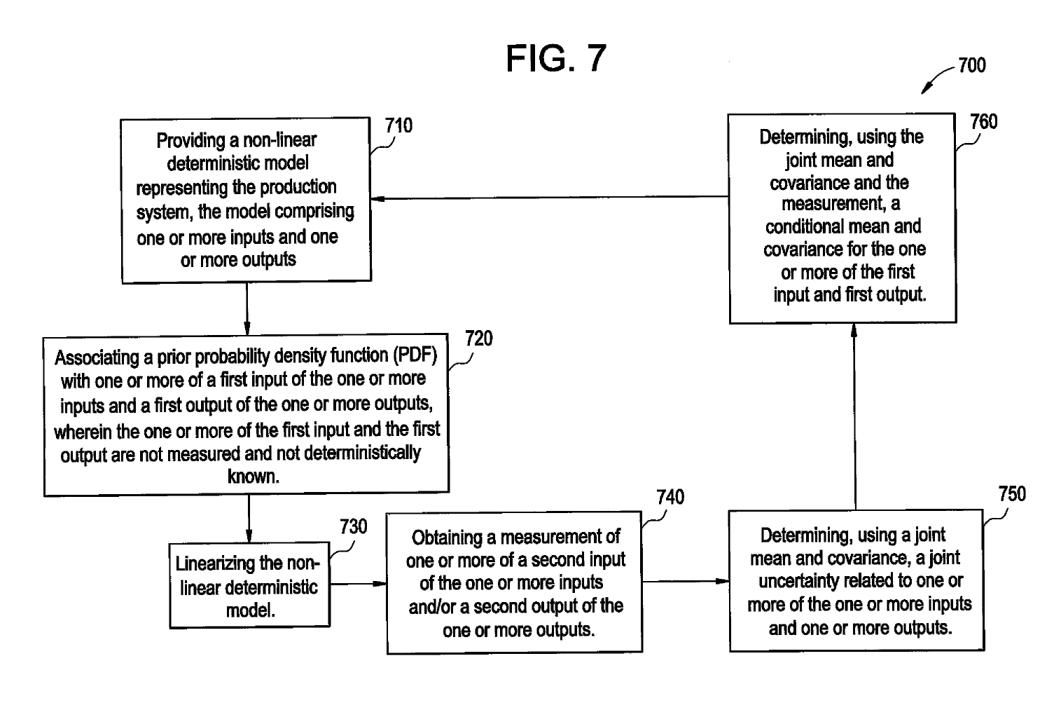

FIG. 7 illustrates an exemplary method of modeling a production system according to an embodiment of the present disclosure. FIG. 7 begins at block 710, which may include providing a non-linear deterministic model representing the production system, the model comprising one or more inputs and one or more outputs. Block 720, may include associating a prior probability density function (PDF) with one or more of a first input of the one or more inputs and a first output of the one or more outputs, wherein the one or more of the first input and the first output are not measured and not deterministically known. Block 730 may include linearizing the non-linear deterministic model. At block 740, a measurement of one or more of a second input of the one or more inputs and/or a second output of the one or more outputs may be obtained. Block 750 may include determining, using a joint mean and covariance, a joint uncertainty related to one or more of the one or more inputs and one or more outputs. Block 760 may include determining, using the joint mean and covariance and the measurement, a conditional mean and covariance for the one or more of the first input and first output.

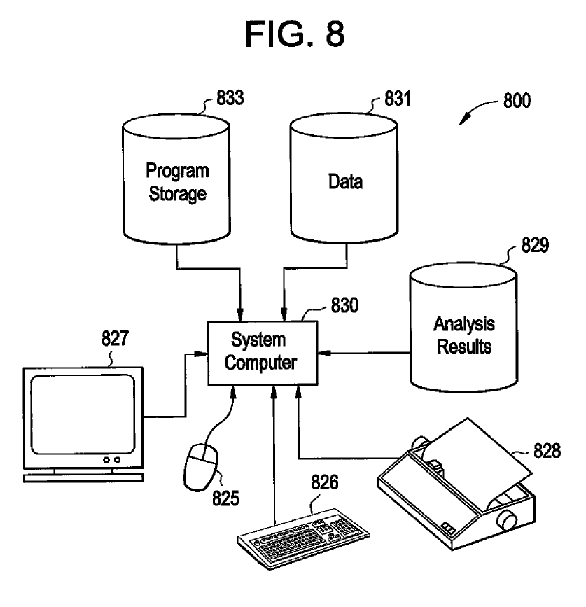

FIG. 8 illustrates a computer system 800 into which implementations of various technologies described herein may be implemented. The computing system 800 (system computer) may include one or more system computers 830, which may be implemented as any conventional personal computer or server. However, those skilled in the art will appreciate that implementations of various techniques described herein may be practiced in other computer system configurations, including hypertext transfer protocol (HTTP) servers, hand-held devices, multiprocessor systems, microprocessor-based or programmable consumer electronics, network PCs, minicomputers, mainframe computers, and the like.

The system computer 830 may be in communication with disk storage devices 829, 831, and 833, which may be external hard disk storage devices. It is contemplated that disk storage devices 829, 831, and 833 are conventional hard disk drives, and as such, will be implemented by way of a local area network or by remote access. Of course, while disk storage devices 829, 831, and 833 are illustrated as separate devices, a single disk storage device may be used to store any and all of the program instructions, measurement data, and results as desired.

In one implementation, exploration and production data may be stored in disk storage device 831. The system computer 830 may retrieve the appropriate data from the disk storage device 831 according to program instructions that correspond to implementations of various techniques described herein. The program instructions may be written in a computer programming language, such as C++, Java and the like. The program instructions may be stored in a computer-readable medium, such as program disk storage device 833. Such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the system computer 830. Communication media may embody computer readable instructions, data structures or other program modules. By way of example, and not limitation, communication media may include wired media such as a wired network or direct-wired connection, and wireless media such as acoustic, RF, infrared and other wireless media. Combinations of any of the above may also be included within the scope of computer readable media.

In one implementation, the system computer 830 may present output primarily onto graphics display 827, or alternatively via printer 828. The system computer 830 may store the results of the methods described above on disk storage, for later use and further analysis. The keyboard 826 and the pointing device (e.g., a mouse, trackball, or the like) 825 may be provided with the system computer 830 to enable interactive operation.

The system computer 830 may be located at a data center remote from where data may be stored. The system computer 830 may be in communication with various databases having different types of data. These types of data, after conventional formatting and other initial processing, may be stored by the system computer 830 as digital data in the disk storage 831 for subsequent retrieval and processing in the manner described above. In one implementation, these data may be sent to the system computer 830 directly from the databases. In another implementation, the system computer 830 may process data already stored in the disk storage 831. When processing data stored in the disk storage 831, the system computer 830 may be described as part of a remote data processing center. The system computer 830 may be configured to process data as part of the in-field data processing system, the remote data processing system or a combination thereof. While FIG. 8 illustrates the disk storage 831 as directly connected to the system computer 830, it is also contemplated that the disk storage device 831 may be accessible through a local area network or by remote access. Furthermore, while disk storage devices 829, 831 are illustrated as separate devices for storing input data and analysis results, the disk storage devices 829, 831 may be implemented within a single disk drive (either together with or separately from program disk storage device 833), or in any other conventional manner as will be fully understood by one of skill in the art having reference to this specification.

While the foregoing is directed to implementations of various technologies described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of modeling a production system, comprising:
providing a non-linear deterministic model representing the production system, the model comprising one or more inputs and one or more outputs;
associating a prior probability density function (PDF) with one or more of a first input of the one or more inputs and a first output of the one or more outputs, wherein the one or more of the first input and the first output are not measured and not deterministically known;
linearizing the non-linear deterministic model;
obtaining a measurement of one or more of a second input of the one or more inputs and/or a second output of the one or more outputs;
determining, using a joint mean and covariance, a joint uncertainty related to one or more of the one or more inputs and one or more outputs;
determining, using the joint mean and covariance and the measurement, a conditional mean and covariance for the one or more of the first input and first output.

2. The method of claim 1, wherein the model further comprises a plurality of time steps, and further comprising:
using a first posterior PDF from a first time step of the plurality of time steps as the prior PDF to be associated with the first input and the first output for a second time step of the plurality of time steps.

3. The method of claim 1, wherein the prior PDF comprises a Gaussian probability density function.

4. The method of claim 1, wherein the non-linear deterministic model comprises a transient model.

5. The method of claim 1, further comprising, scheduling one or more well tests that reduces an a posteriori uncertainty associated with the model.

6. The method of claim 1, further comprising updating the non-linear deterministic model based on the conditional mean and covariance.

7. The method of claim 1, further comprising, calibrating a sensor based on the conditional mean and covariance.

8. A system for modeling a production system, comprising:
a memory;
a processor operatively connected to the memory and having functionality to execute instructions for:
providing a non-linear deterministic model representing the production system, the model comprising one or more inputs and one or more outputs;
associating a prior probability density function (PDF) with one or more of a first input of the one or more inputs and a first output of the one or more outputs, wherein the one or more of the first input and the first output are not measured and not deterministically known;
linearizing the non-linear deterministic model;
obtaining a measurement of one or more of a second input of the one or more inputs and/or a second output of the one or more outputs, wherein the second input and the second output have been previously measured;
determining, using a joint mean and covariance, a joint uncertainty related to one or more of the one or more inputs and one or more outputs;
determining, using the joint mean and covariance and the measurement, a conditional mean and covariance for the one or more of the first input and first output.

9. The system of claim 8, wherein the model further comprises a plurality of time steps, and the processor having further functionality to execute instructions for:
using a first posterior PDF from a first time step of the plurality of time steps as the prior PDF to be associated with the first input and the first output for a second time step of the plurality of time steps.

10. The system of claim 8, wherein the prior PDF comprises a Gaussian probability density function.

11. The system of claim 8, wherein the non-linear deterministic model comprises a transient model.

12. The system of claim 8, the processor having further functionality to execute instructions for scheduling one or more well tests that reduces an a posteriori uncertainty associated with the model.

13. The system of claim 8, the processor having further functionality to execute instructions for updating the non-linear deterministic model based on the conditional mean and covariance.

14. The system of claim 8, the processor having further functionality to execute instructions for calibrating a sensor based on the conditional mean and covariance.

15. A computer readable storage medium storing instructions for modeling a production system, the instructions when executed causing a processor to:
provide a non-linear deterministic model representing the production system, the model comprising one or more inputs and one or more outputs;
associate a prior probability density function (PDF) with one or more of a first input of the one or more inputs and a first output of the one or more outputs, wherein the one or more of the first input and the first output are not measured and not deterministically known;
linearize the non-linear deterministic model;
obtain a measurement of one or more of a second input of the one or more inputs and/or a second output of the one or more outputs, wherein the second input and the second output have been previously measured;
determine, using a joint mean and covariance, a joint uncertainty related to one or more of the one or more inputs and one or more outputs;
determine, using the joint mean and covariance and the measurement, a conditional mean and covariance for the one or more of the first input and first output

16. The computer readable storage medium of claim 15, wherein the model further comprises a plurality of time steps, and the instructions when executed further causing the processor to:
using a first posterior PDF from a first time step of the plurality of time steps as the prior PDF to be associated with the first input and the first output for a second time step of the plurality of time steps.

17. The computer readable storage medium of claim 15, wherein the prior PDF comprises a Gaussian probability density function.

18. The computer readable storage medium of claim 15, wherein the non-linear deterministic model comprises a transient model.

19. The computer readable storage medium of claim 15, the instructions when executed further causing the processor to schedule one or more well tests that reduces an a posteriori uncertainty associated with the model.

20. The computer readable storage medium of claim 15, the processor having further functionality to execute instructions for calibrating a sensor based on the conditional mean and covariance.
